(19) United States
(12) Patent Application Publication
(10) Pub. No.: US 2015/0213194 A1
(43) Pub. Date: Jul. 30, 2015

(54) Methods, Devices, And Systems For Multi-Format Data Aggregation

(71) Applicants: William B Wolf, (US); Steven G Lamb, (US); Systemedical, LLC, Middleburg, VA (US)

(72) Inventors: William B. Wolf, Middleburg, VA (US); Steven G. Lamb, Middleburg, VA (US)

(73) Assignee: Systemedical, LLC, Middleburg, VA (US)

(21) Appl. No.: 14/544,624

(22) Filed: Jan. 28, 2015

Related U.S. Application Data
(60) Provisional application No. 61/933,768, filed on Jan. 30, 2014.

(51) Int. Cl. G06F 19/00; G06K 9/20

(52) U.S. Cl. CPC G06F 19/322; G06K 9/2054; G06K 2209/01

(57) ABSTRACT

Methods, devices, and systems for multi-format data aggregation, from disparate sources. According to an aspect, a method of populating a personal health record (PHR) with data culled from a plurality of images of a plurality of printed documents provided by a plurality of medical providers to a patient at a plurality of points of care after the patient visits the plurality of medical providers may be provided.

### CROSS-REFERENCE TO RELATED APPLICATIONS

This application claims priority from U.S. Prov. Pat. Ser. No. 61,933,768, filed Jan. 30, 2014, entitled “Methods, Devices, and Systems to Empower Patients' Meaningful Use of After-Visit Summaries”, which is hereby incorporated by reference herein.

### TECHNICAL FIELD

The present invention relates to methods, devices, and systems for multi-format data aggregation, from disparate sources, and that, from a central account, present pertinent subsets of account data to necessary parties, while collectively using the aggregated data to, for example, identify adverse outcomes resulting from certain decisions before such outcomes would be recognized using today's methods of collecting and analyzing data.

### BACKGROUND

The following discussion is intended to provide a background or context to the embodiments described herein. The concepts described may or may not have been previously conceived or pursued. Accordingly, what is described should not be interpreted as admitted prior art.

Standards requiring formatting of data according to a structured format may in theory suggest uniformity in resulting data formats. However, in practice, differing data formats often result for multiple reasons. As a specific context example, Centers for Medicare & Medicaid Services (CMS) Incentive Programs promulgated a three stage program to govern the use of Electronic Health Records (EHRs) in the United States as part of the American Recovery Act. A great deal of information about what will be referred to herein as the “Meaningful Use” program is available at the CMS website (http://www.cms.gov/Regulations-and-Guidance/Legislation/EHRIncentivePrograms/Meaningful_Use.html).

The Meaningful Use program provides sets of “core” objectives and “menu” objectives for each of the three stages of the program. Medical professionals and certain hospitals (collectively or individually referred to herein as “medical providers”) can earn monetary incentives for operating in ways that achieve the objectives of each of the three stages. The CMS trusts that if medical providers meet the objectives of the Meaningful Use program, they will in fact be making meaningful use of electronic health records.

Among the core objectives for Stage 2, for example, are the objectives of “Provid[ing] clinical summaries for patients for each office visit.” A certified EHR system will meet, among other requirements, the requirement of 37 CFR 170.304(h) to: “Enable a user to provide clinical summaries to patients for each office visit that include, at a minimum, diagnostic test results, problem list, medication list, and medication allergy list . . . . ” Hereinafter, these clinical summaries may be referred to as “after-visit summaries.”

Medical providers must use certified EHR technology to ensure that the technology is suitable to meet the objectives of Meaningful Use. CMS provides guidance on the requirements of certified EHR technology. “In order to capture and share patient data efficiently, medical providers need an EHR that stores data in a structured format. Structured data allows patient information to be easily retrieved and transferred, and it allows the medical provider to use the EHR in ways that can aid patient care.” http://www.cms.gov/Regulations-and-Guidance/Legislation/EHRIncentivePrograms/Certification.html, downloaded Dec. 16, 2013.

The Government mandates the use of “standards” for content exchange and vocabulary for exchanging electronic health information. See 45 CFR §170.205. For example, the “vocabulary” standards for specifying the code set, terminology, or nomenclature to use to represent health information included in an after-visit summary are specified at 45 CFR 162.1002(a)(1), which indicates that the vocabulary should comply with “International Classification of Diseases, 9th Edition, Clinical Modification, (ICD-9-CM), Volumes 1 and 2 (including The Official ICD-9-CM Guidelines for Coding and Reporting), as maintained and distributed by HHS, for the following conditions: (i) Diseases. (ii) Injuries. (iii) Impairments. (iv) Other health problems and their manifestations.

These standards, however, are not as precise as needed for seamless sharing between a multitude of EHR systems presently being marketed by what may be 1,000 EHR vendors (as used herein, the word “vendors” is not meant to be limiting and may include, for example, developers, service providers, or other entities involved in the EHR industry). While individual EHR vendors may provide for sharing of patient data between their own proprietary systems, sharing of patient data between systems of different EHR vendors has proven to be difficult, if not impossible. Each EHR vendor believes in the superiority of the data format and structure used by its product. There are no incentives for EHR vendors to create software to effect conversion of data stored in their systems to a format and structure used by a competitor's system. An EHR vendor desires to acquire the entire market; not share the market with its competitors. Providing interoperability would defeat the commercial purpose of an EHR vendor. Therefore, while national interoperability appears to be a goal of the US Government, it is not attainable using the current framework. In other words, the standards requiring formatting of data according to the structured format actually result in many differing formats, due to a lack of precision in the standards themselves, and also to differing interpretations of the standards by competing adopters of the standards.

Differing data formats may be undesirable for many reasons. Turning back to the medical records context example, many patients, for example, the chronically ill and the elderly, see many medical providers and may spend time in more than one hospital in the course of a year. Other patients may see, for example, one doctor for a number of years but then switch to another doctor in a different practice. Patients on travel may need to visit an emergency room in a hospital that is new to the patient. It is also common for general practice physicians to refer a patient to a specialist, such as a cardiologist or a gastroenterologist, outside of the physician's practice group. At least because it is highly improbable that all of the medical providers and hospitals providing services to a given patient use the same EHR system, the patient loses the benefit of having the opportunity to share his or her medical data with the physician currently treating the patient. The patient will therefore be deprived of benefits that the electronic sharing of medical data promises to offer. In other words, the differing data formats hamper effective aggregation of data from disparate sources. Lack of effective aggregation of the data from disparate sources hampers effective distribution of subsets of the aggregated data to parties that may have a need to access the data. Lack of effective distribution of the subsets of the aggregated data prevents identification of adverse outcomes resulting from making certain decisions.

What is needed are methods, devices, and systems that can overcome one or more of the deficiencies described above.

### SUMMARY

According to an aspect of the invention, a method of populating a personal health record (PHR) with data culled from a plurality of images of a plurality of printed documents provided by a plurality of medical providers to a patient at a plurality of points of care after the patient visits the plurality of medical providers may be provided. The method may include receiving at a point of care, at a processor of a mobile device, electronic data representative of an image of a printed document. The method may include applying the electronic data to an optical character recognition program configured to convert the image of the printed document into text. The method may include parsing the text into a plurality of fields, the plurality of fields comprising data representative of information related to the patient's visit to a medical provider. The method may include storing the parsed text in a database. The method may include displaying at least some of the text on a display screen of the mobile device. A presentation format of the printed document may differ from a presentation format of at least one of the plurality of printed documents.

According to another aspect of the invention, a mobile device may be provided. The mobile device may include a camera, a transmitter, a memory, and a processor operatively coupled to the camera, transmitter, and memory. The memory may include instructions that when executed by the processor cause the processor to receive electronic data representative of an image of a printed document from the camera, apply the electronic data to an optical character recognition program configured to convert the image of the printed document into text; parse the text into a plurality of fields, the plurality of fields comprising data representative of information related to a patient's visit to a medical provider, and transmit the parsed data, from the transmitter. The transmitted data may be stored in a database remote from the mobile device. The mobile device may be used at a point of care to record the image of the printed document provided by the medical provider to the patient at the point of care. A presentation format of the printed document may differ from a presentation format of at least one other printed document received as electronic data from the camera.

According to another aspect of the invention, a system for recording and monitoring health parameters of a user may be provided. The system may include a first device configured to receive and store data representative of at least one health parameter of the user, and a second device configured to measure the at least one health parameter of the user and transmit data representative of the at least one health parameter of the user to the first device. The first device may be further configured to compare the received data representative of the at least one health parameter of the user with the stored data and transmit a notification if a result of the comparison exceeds a predetermined limit.

According to another aspect of the invention, a method of obtaining medical information of a patient by a third party may be provided. The method may include receiving, at a processor of a system configured to aggregate medical data of a plurality of users from a plurality of disparate sources and store the aggregated data in a structured database, a signal indicative of a command to display at least one screen configured to allow selection of data personal to one of the plurality of users from the structured database. The method may further include verifying that the received signal is from an entity authorized to retrieve personal data of the user, and executing commands that cause a response signal to be transmitted. The responsive signal may be representative of a denial to retrieve the personal data, if the received signal is not from an authorized entity, or the responsive signal may be representative of a selection screen identifying personal data available to the authorized entity receiving a signal indicative of a section of the personal data. The method may further include retrieving and formatting for transmission the selected personal data, and transmitting the selected data to the authorized entity.

Additional scope of applicability of the present application will become more apparent from the brief description of an embodiment of the invention given hereinafter. However, it should be understood that the brief description of the embodiment of the invention and specific examples, which indicate preferred embodiments, are given by way of illustration only. Various changes and modifications within the spirit and scope of the disclosure will become apparent to those skilled in the art from the description that follows.

### BRIEF DESCRIPTION OF THE DRAWINGS

The accompanying drawings, which are included to provide a further understanding of the disclosure and are incorporated in and constitute a part of this specification, illustrate exemplary embodiments, and together with the brief description of an embodiment of the invention, serve to explain the principles of the disclosure.

FIG. 1 is a block diagram of a mobile device and a server that may be used to implement a method in accordance with an embodiment of the invention.

FIGS. 2A through 2B illustrate data presented in one type of format, on paper copies of after-visit summaries, which was generated one type of Electronic Health Record system.

FIGS. 2C-2I illustrate data that is identical to FIGS. 2A and 2B but presented in a different type of format, on paper copies of an after visit summary, generated by a different type of Electronic Health Record system than shown in FIGS. 2A and 2B.

FIG. 3 is a block diagram illustrating a variety of medical providers of after-visit summaries, or other patient health-related data, and demonstrates the interaction between the mobile device, server, and communication network when such after-visit summaries and health-related data are input to a system in accordance with an embodiment of the invention.

FIG. 4 is a flow diagram of a method in accordance with an embodiment of the invention.

FIG. 5 is a flow diagram of a second method in accordance with an embodiment of the invention.

FIG. 6 is a flow diagram of a third method in accordance with an embodiment of the invention.

FIG. 7 is a flow diagram of a fourth method in accordance with an embodiment of the invention.

FIGS. 8-11 are data flow diagrams in accordance with embodiments of the invention.

### BRIEF DESCRIPTION OF EMBODIMENTS OF THE INVENTION

Description will now be given in detail of methods, devices, and systems according to the exemplary embodiments disclosed herein, with reference to the accompanying drawings.

As used in the following discussion, the terms “a”, “an” and “the” may refer to one or more than one of an element (e.g., item or act). Similarly, a particular quantity of an element may be described or shown while the actual quantity of the element may differ. The terms “and” and “or” may be used in the conjunctive or disjunctive sense and will generally be understood to be equivalent to “and/or”. References to “an” or “one” embodiment are not necessarily all referring to the same embodiment. Elements from an embodiment may be combined with elements of another. No element used in the description of this application should be construed as critical or essential to the invention unless explicitly described as such. Further, when an element is described as “connected,” “coupled,” or otherwise linked to another element, it may be directly linked to the other element, or intervening elements may be present.

Embodiments of the present invention use optical image capturing devices, that have become ubiquitous at every level of society in the United States, to capture images of printed data, such as diagnosis and test results, convert those images to text, parse, categorize, analyze, and store the data as structured data in one or more databases to thereby improve aggregation of the data, to improve the distribution of subsets of the aggregated data to necessary parties, and to thereby improve identification of adverse outcomes resulting from making certain decisions based on the subsets of the aggregated data (e.g., outcomes of individuals within the group of participants and the group itself). In an embodiment relating to the context example of after-visit summaries provided medical providers, a camera of a mobile device such as a mobile phone or a tablet computing device may capture an image a printed document (e.g., after-visit summary) as electronic data representative of the image, that is, an image file. The image file of the printed document may be received into a processor of the mobile device. The image file may be applied to an optical character recognition (OCR) program to convert the image file into text. The text may be applied to a parsing/mapping function to parse the text into multiple fields of data representative of information related to, for example, a patient's visit to a medical provider. The parsed text, that is, the mapped data, may be received into a database of a server remote to the mobile device. Thereafter, when needed, at least some of the mapped data may be delivered to and displayed on a screen of the mobile device. It should be noted that the operations of capturing an image, receiving the image file into the processor, applying the image file to the OCR program, applying the text to the parsing/mapping function, and receiving the mapped data into the database may be repeated for printed documents of differing formats and from differing providers. It should also be noted that the operation of delivering and displaying at least some of the mapped data may include delivering and displaying data ultimately from printed documents of differing formats.

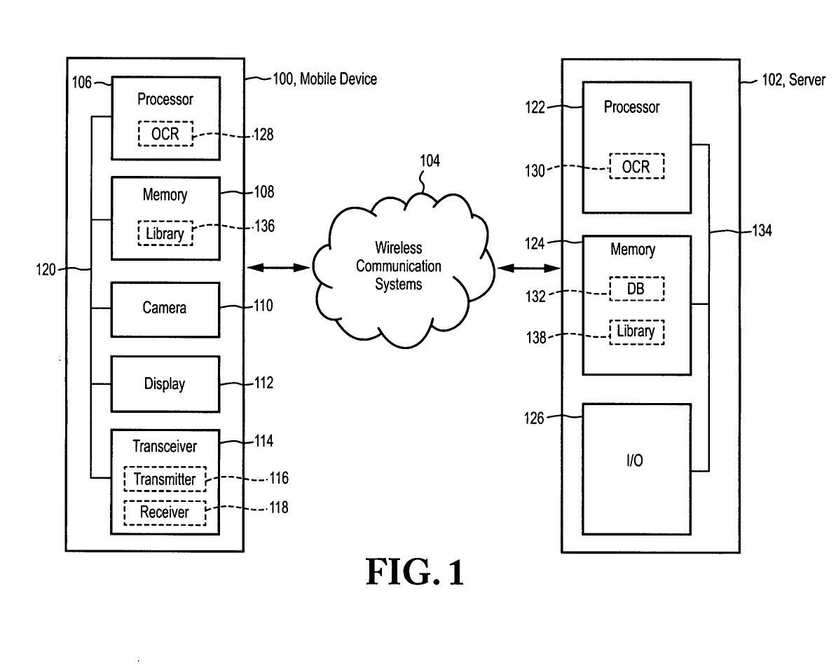

Turing to the figures, FIG. 1 is a block diagram of a mobile device 100 and a server 102 that may be used to implement a method in accordance with an embodiment of the invention. In accordance with one embodiment, communication between the mobile device 100 and the server 102 may be via Internet and/or any of the numerous wireless communication systems 104 known to those of skill in the art. Such systems 104 may include, but are not limited to, 3G, 4G, and Wi-Fi. Any combination of these systems 104, and/or any combination of packet-switched and circuit-switched communication systems may be used to accomplish communication between one or more mobile devices 100 and one or more servers 102 without departing from the scope of the invention.

The mobile device 100 may comprise a processor 106, a memory 108, a camera 110, a display 112, and a transceiver 114. The display 112 may be, for example, an LCD display, an LED display, an organic LED display, or any other type of display suitable for use with a mobile device 100 in accordance with the knowledge of one of skill in the art. As known to those of skill in the art, a transceiver 114 may be comprised of a transmitter 116, a receiver 118, and additional digital/analog circuitry (not shown) necessary to effect communications. The above-recited components of the mobile device 100 may be operationally coupled to the processor 106 by one or more communications busses 120.

The server 102 may comprise a processor 122, a memory 124, and an input/output (I/O) 126 device or system. Any type of I/O 126 device or system, or combinations of devices and/or systems, suitable to effect communications between the mobile device 100 and the server 102 is within the scope of the invention. The above-recited components of the server 102 may be operationally coupled to the processor 122 by one or more communications busses 134. As used in the exemplary embodiments described herein, the server 102 may be a centralized or distributed system utilized to receive, store, and/or analyze data from a plurality of mobile devices 100, 308, emergency call centers 314, first responders 316, and/or hospitals 318. The server 102 may be further utilized to transmit data to one, all, or a subset of the plurality of mobile devices 100, 308, emergency call centers 314, first responders 316, and/or hospitals 318.

In accordance with one embodiment of the invention, the processor 106 of the mobile device 100 may receive data representative of an image of an after-visit summary taken by a user using the camera 110 of the mobile device. The image may be captured at the point of care (e.g., at the location of a medical provider). In one embodiment of the invention, the processor 106 of the mobile device may execute instructions to run an optical character recognition (OCR) program 128 resident on the mobile device 100. The OCR program 128 may process the received data representative of the image of the after-visit summary to produce an editable file, such as an editable text file, Hyper Text Markup Language (HTML) file, or any other editable file known to those of skill in the art. Those of skill in the art will appreciate that “editable text” refers to text that is not only editable, but searchable. Additional processing, which will be discussed later, may be performed on the data comprising the editable file. In another embodiment of the invention, the processor 106 of the mobile device 100 may execute instructions to transfer the received data representative of the image of the after-visit summary to a server 102. The data may be stored in the memory 124 of the server 102 and processed by an OCR program 130 resident on the server 102. The processor 122 of the server 102 may then execute instructions to run the OCR program 130. OCR programs 128, 130 used in the mobile device 100 and server 102 may be different from one-another. In still another embodiment (not shown), OCR functionality may be shared by the processor 106 of the mobile device 100 and the processor 122 of the server 102.

In accordance with one embodiment of the invention, the memory 108 of the mobile device 100 may include a library 136 of images, or templates that correspond to images of printed after-visit summaries generated by multiple diverse EHR systems. In accordance with another embodiment of the invention, the memory 124 of the sever 102, may include a library 138 of images, or templates that correspond to images of printed after-visit summaries generated by multiple diverse EHR systems. In accordance with still another embodiment of the invention, images, or templates that correspond to images of printed after-visit summaries generated by multiple diverse EHR systems may be stored in both the memories 108, 124 of the mobile device 100 and server 102, respectively. Diverse EHR systems may include systems developed by one vendor or by a plurality of unrelated vendors. The size and content of the libraries 136, 138 need not be identical.

The memory 108 of the mobile device 100 and/or the memory 124 of the server 102 may store executable instructions used to practice a method in accordance with an embodiment of the invention. Additionally, or alternatively, subsets or portions of executable code used to practice a method in accordance with an embodiment of the invention may be stored in either memory 108, 124.

The memory 124 of the server 102 may include space reserved for storage of structured data that populates a database 132 used in the practice of an embodiment of a method of the invention. Although embodiments described herein utilize structured data, it is within the scope of the invention to use unstructured or semi-structured data.

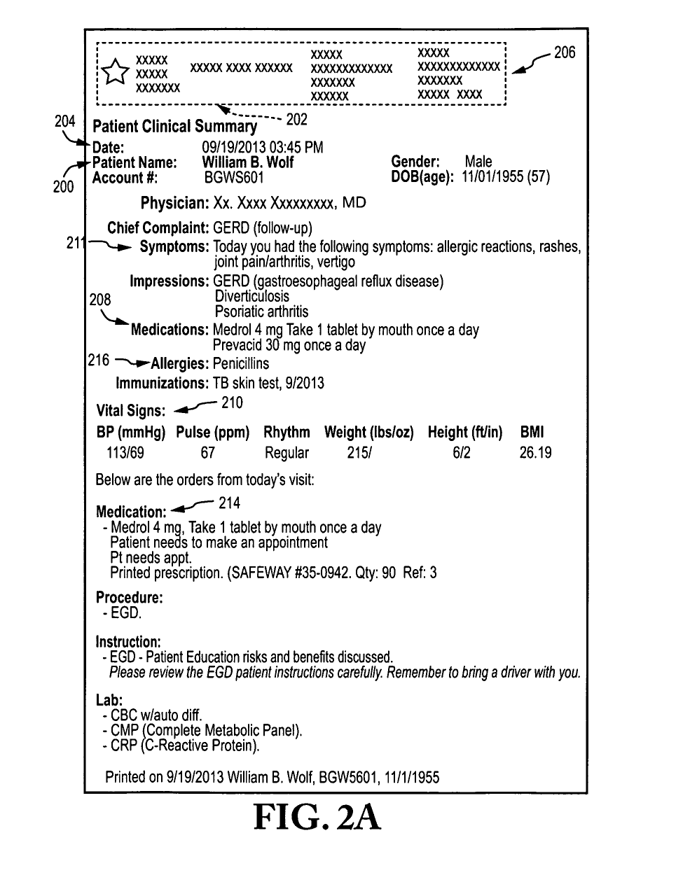

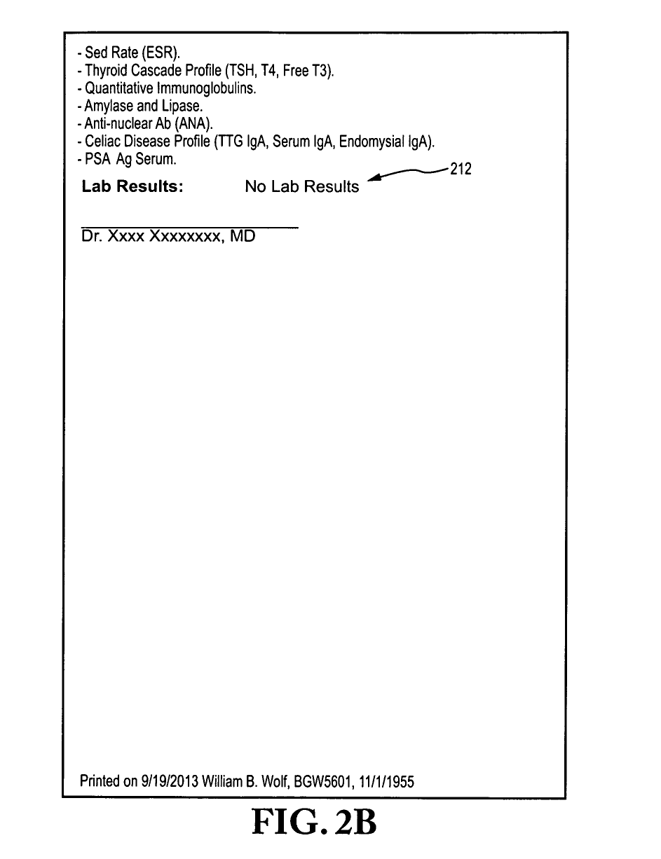

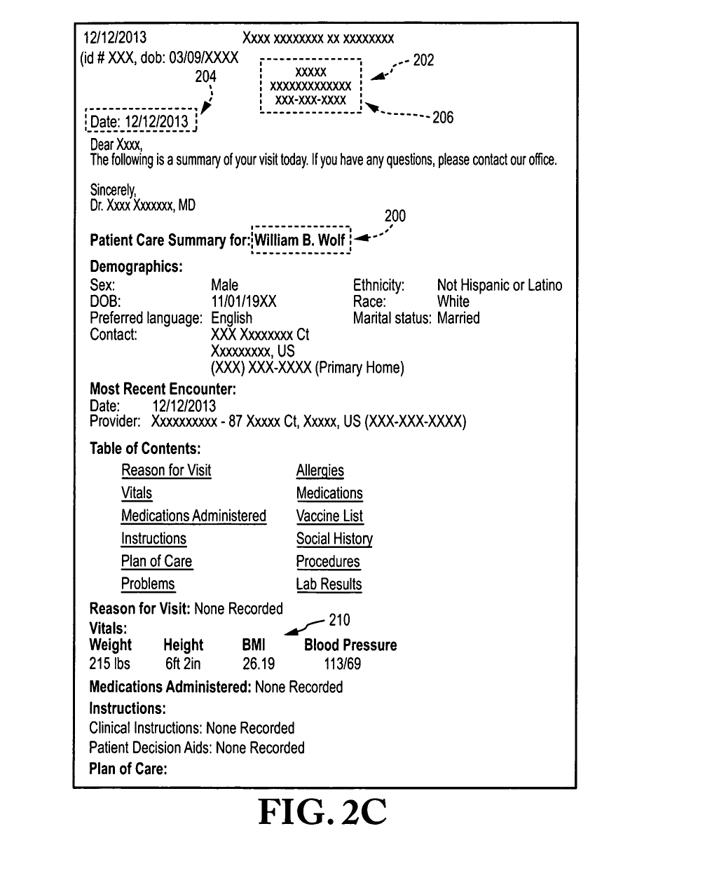

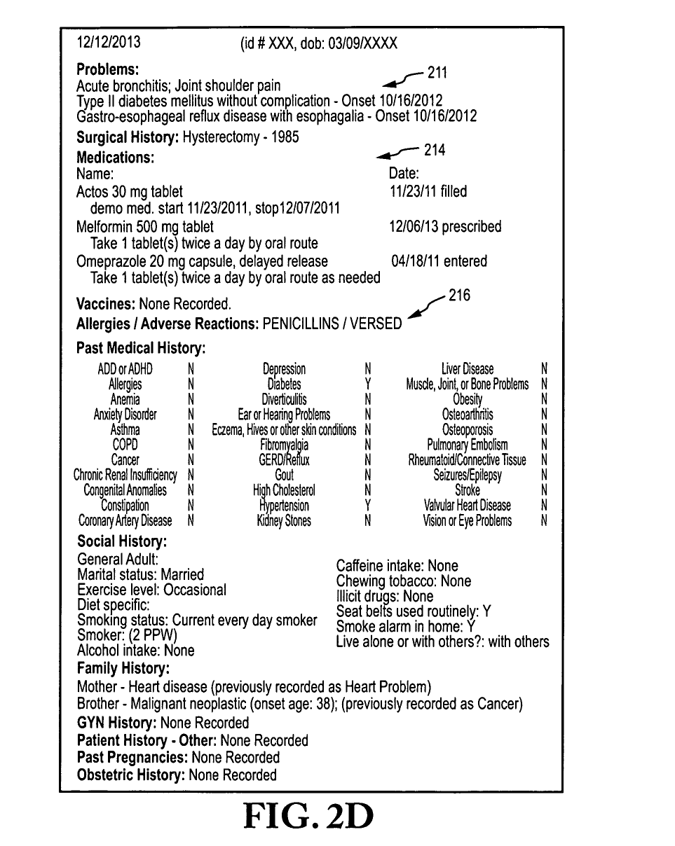

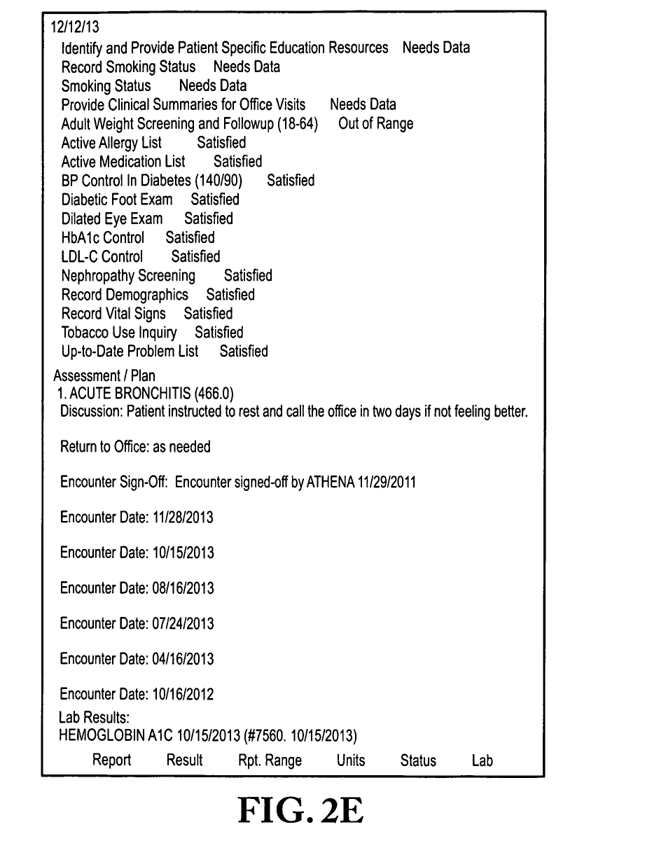

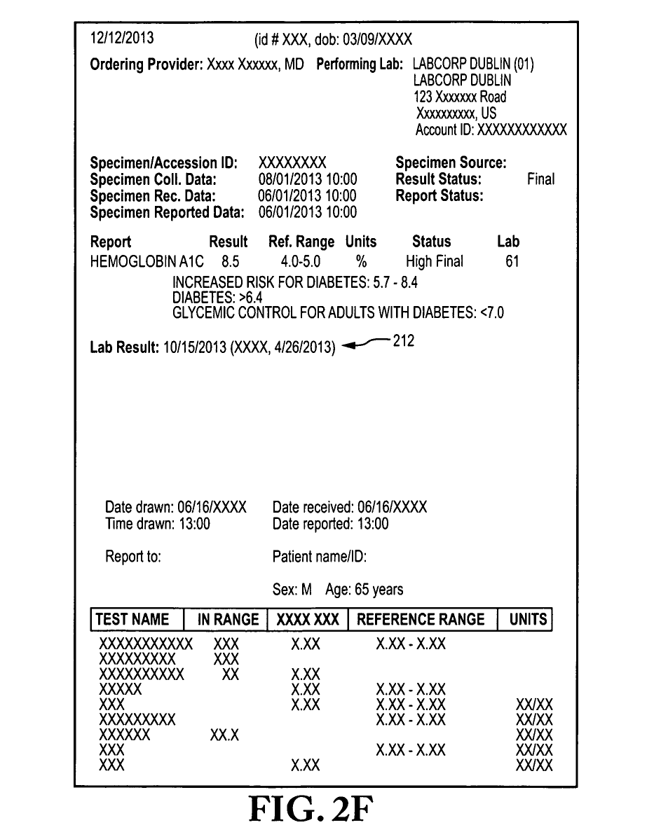

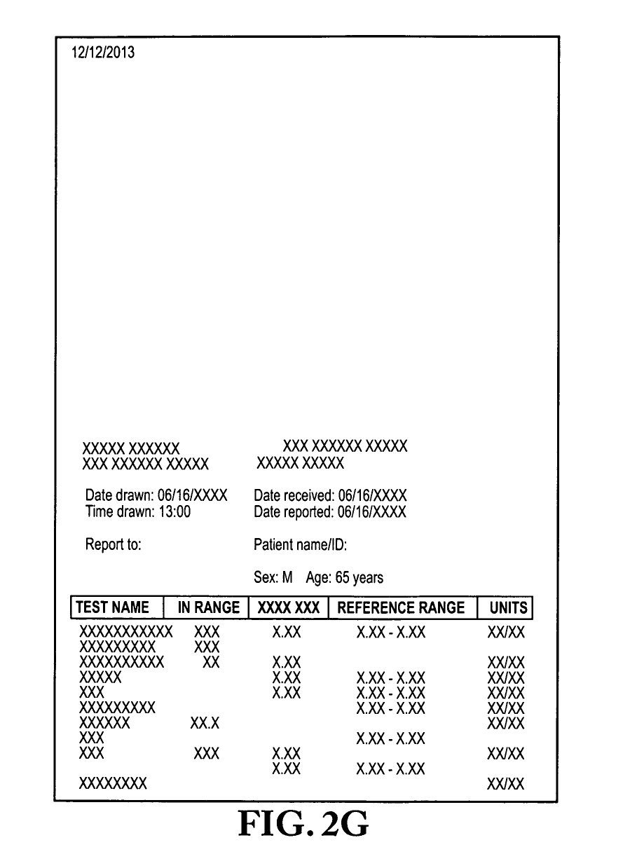

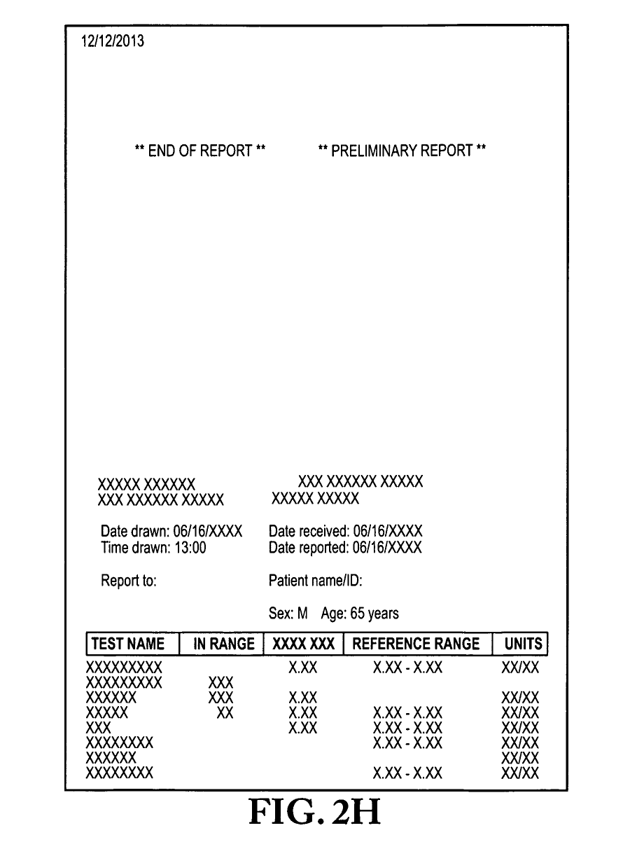

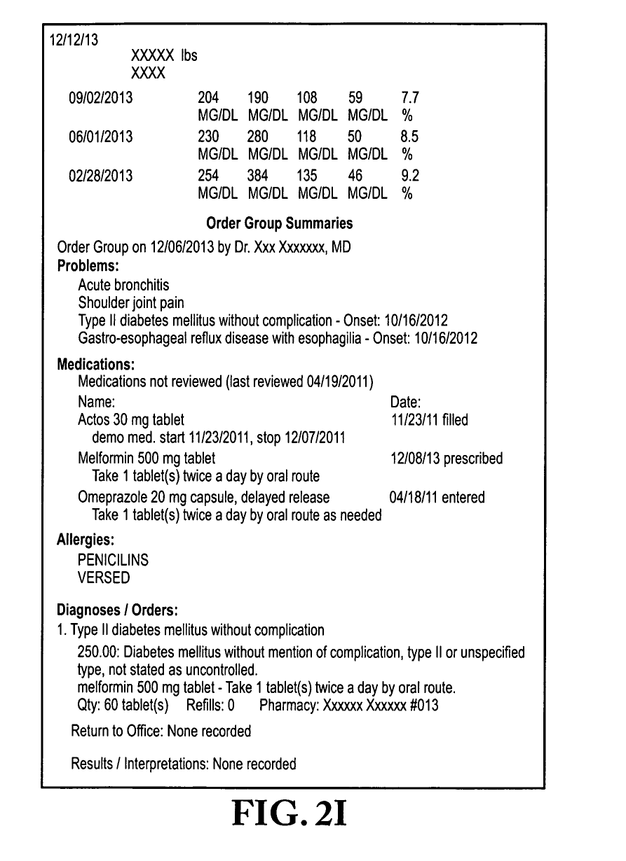

FIGS. 2A-2 and FIGS. 2C-2I are reproductions of after-visit summaries generated by two different Electronic Health Record systems. In accordance with Meaningful Use core measures, stage 1, a medical care provider must provide an after-visit summary to each patient after the patient's visit with the medical provider. The after-visit summary includes information and instructions that may be required or useful to the patient. The categories of information and instructions are denoted by, what is described herein as, field descriptors. It is believed that the field descriptors used by many EHR vendors will be the same or similar to one another, because the vendors may choose to use the terms specified in the EHR incentive program. Field descriptors presented in the after-visit summary may include, for example, the patient's name 200, the medical provider's office contact information 202, the date 204 and location 206 of the visit, an updated medication list 208, an updated listing of vital signs 210, a problem list 210, diagnostic (laboratory) test results 212, a medication list 214, and a medication allergy list 216. As exemplified in FIGS. 2A(-1 and -2) and 2B(-1 through -7), the text of filed descriptors identifying the same category are the same or similar to one another, however, the location and presentation of the field descriptors, and the data associated with the field descriptors, are not identical. That is, the presentations formats of the two after-visit summaries are different.

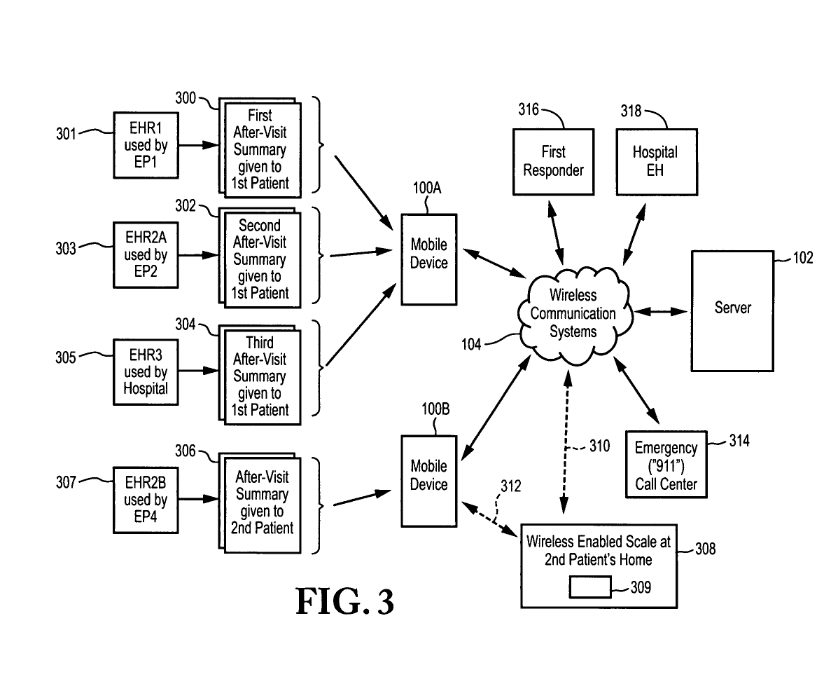

FIG. 3 is a block diagram illustrating a variety of after-visit summaries 300, 302, 304, 306, provided to first and second patents by a plurality of eligible medical providers (EP1, EP2, and EP4) and an eligible hospital via their respective EHR systems 301, 303, 305, 307. FIG. 3 additionally illustrates a wireless enabled scale 308 at the second patient's home. The wireless enabled scale 308 may be of a type the can transmit information to the server 102 via the communication network 104 (see double headed arrow 310) or to the server 102 via the second patient's mobile device 100B (see double headed arrow 312) or a wireless connection within the second patient's home (not shown), via its own transmitter or transceiver 309. FIG. 3 additionally illustrates an interoperability between an emergency call center (e.g., a 911 call center) 314, mobile devices 100A, 100B, 308, and a system (including sever 102), all in accordance with an embodiment of the invention.

As illustrated in the example of FIG. 3, a first patient may visit eligible medical provider EP1. EP1 could be, for example, the first patient's primary care doctor. At the conclusion of the patient's visit with EP1, the patient is entitled to receive an after-visit summary. EP1 may use a first type of electronic health record system, EHR1, to provide the patient with a paper copy of the patient's after-visit summary 300.

The patient's primary care doctor may refer to patient to a second doctor, for example a specialist in cardiology, EP2. At the conclusion of the patient's visit with EP2, the patient is entitled to receive an after-visit summary. EP2 may use a second type of electronic health record system, EHR2A, to provide the patient with a paper copy of the patient's after-visit summary 302.

Sometime later, the patient may experience shortness of breath. The patient may be taken to an eligible hospital for emergency room evaluation and treatment. At the conclusion of the patient's stay at the eligible hospital, the patient is entitled to receive an after-visit summary. EH may use a third type of electronic health record system, EHR3, to provide the patient with a paper copy of the patient's after-visit summary 304. EHR1, EHR2A, and EHR3 were not provided by the same vendor. Consequently, it is highly probable that each of the first, second, and third after-visit summaries 300, 302, 304 given to the first patient have dissimilar appearances. That is, they are differently formatted. Nevertheless, the first, second, and third after-visit summaries 300, 302, 304 may utilize field descriptors (e.g., patient name 200, problem list 210, etc.) that are identical or similar.

Meanwhile, a second patient has been seen by a fourth medical provider EP4, who is coincidentally a cardiologist. As an additional coincidence, and not because they are both cardiologists, EP4 uses the same electronic health records system as EP2; that is, each uses his own EHR2 system (identified as EHR2A and EHR2B), provided by the same vendor. In this example, EP4 and EP2 are not in the same practice. The individual EHR2 systems are not shared or connected to each other in any way. It is important to note that the coincidental use of two distinct EHR2 systems by two unassociated cardiologists is only for exemplary purposes and is not intended to limit the invention in any way. At the conclusion of the second patient's visit with EP4, the patient is entitled to receive an after-visit summary. EP4 uses EHR2B to provide the patient with a paper copy of the patient's after-visit summary 306. It will be understood that because medical providers EP2 and EP4 use the same type of EHR system, the format of the after-visit summaries 302, 306 given to the first patient and the second patient are most probably identical, or nearly identical.

Electronic health records are owned by medical doctors. Everything within the electronic health record is presumed to be medically filtered. In contrast, patient health records are owned by their patients. Everything within a patient health record is presumed to be not medically filtered. For example, one might find, in a patient health record, a description of the patient having chest pain. This description is not medically filtered. For example if the patient is a 22-year-old, the patient may have chest pain because he just played rugby and he now has a clavicle fracture. Instead of recording “chest pain” in an electronic health record, a medical provider would record a medical diagnosis. The medical diagnosis might be indicated in accordance with the international classification of diseases (ICD) standard. Therefore, the medical provider might enter an ICD code of 801.02, to represent the medical diagnosis of “a closed clavicle fracture of shaft of clavicle.”

After-visit summaries are generated using data from a medical provider's EHR. According to the Meaningful Use program, a patient is entitled to receive a copy of an after-visit summary from each medical provider. The copy may be provided in a “human readable” format, meaning the after-visit summary can be provided electronically, if it is formatted to allow patient to open and read the after-visit summary, for example, in a word processing program or as a PDF-type document. See 37 CFR 170.304(h). Alternatively, the medical provider may choose to provide a paper copy of the after-visit summary to her patients. Additionally, if the medical provider selects to provide patients with electronic copies of after-visit summaries, meaningful use Stage 1 mandates that, upon request, a patient should receive a paper copy of the data being provided in electronic format.

Patients that receive their after-visit summaries in paper form may not be able to obtain the benefit envisioned for the patient by the Meaningful Use program. By way of example, a patient might consider storing all of her after-visit summaries in one physical file folder, or might consider entering the data from the after-visit summary into an electronic personal health record maintained by the patient. Problems, however, are associated with these patient practices. For example, the patient may lose paper copies of after-visit summaries, may forget to file all of the after-visit summaries in one location, or may forget to enter the data from their paper copies into their electronic personal health records. In these exemplary instances, a patient's personal health record would be missing important sets of data.

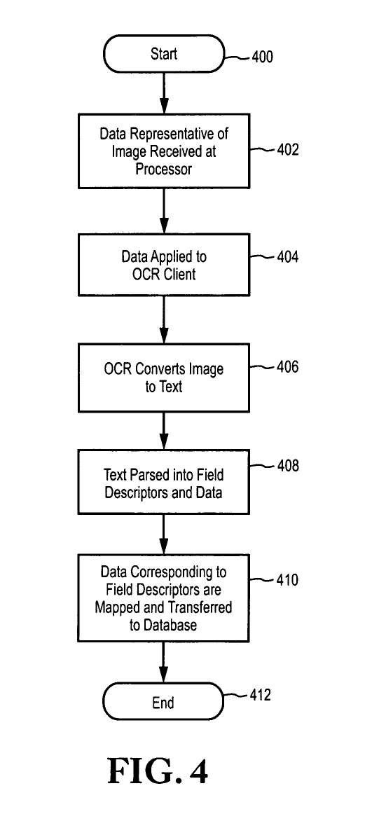

In order to correct at least this problem, one embodiment of the invention utilizes a camera 110 of a mobile device 100 (for example a mobile phone, personal digital assistant, or e-book) to record an image of each sheet of paper of an after-visit summary. The recorded image of the after-visit summary may be captured at the point of care, for example in an examination, consultation, or waiting room associated with the medical provider. Additional processing of the recorded images, to achieve an even greater benefit of the use of the invention, will be discussed in connection with FIGS. 4-6.

Returning to FIG. 3, by way of example, the first patient may use his mobile device 100A to capture an image of his first after-visit summary 300, his second after-visit summary 302, and his third after-visit summary 304. Capture of any of these images may occur immediately after receipt of the after-visit summary from the medical provider, at the point of care, or at a later time or date. Furthermore, the second patient may use his mobile device 100B to capture an image of his after-visit summary 306. Mobile devices 100A and 100B need not be identical, but may have similar features. Several features common to mobile devices 100A and 100B are described with respect to mobile device 100 in FIG. 1 and will not be repeated for purposes of conciseness.

Gaining a benefit from storing images of after-visit summaries on a patient's mobile device or on a patient's computer may prove to be as problematic as storing physical pieces of paper. Additionally, storing images of text provides little utility in the event that the patient wishes to identify one particular set of words or combination of words from among many images.

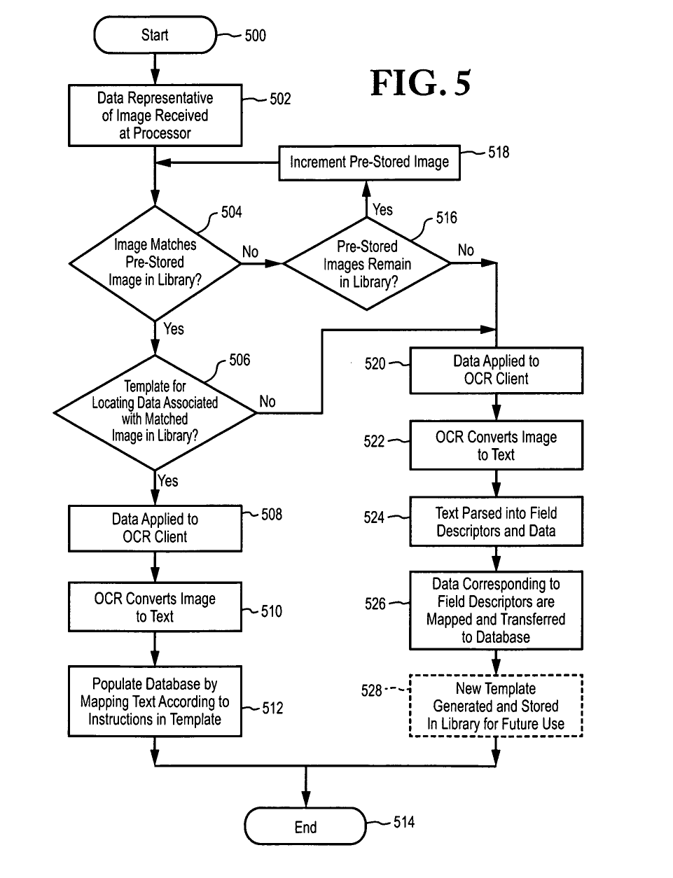

Therefore, in accordance with an embodiment of the invention, the image of the after-visit summary may be provided to an optical character recognition (OCR) program, which may reside and be executed in whole or in part on either or both of the mobile device 100 (OCR 128, FIG. 1) or the server 102 (OCR 130, FIG. 1). In an embodiment, the optical character recognition (OCR) program may capture an image of an after-visit summary in a foreign language but stored in the database 132 in English so as to remove a language barrier between providers. Exemplary embodiments of methods of processing an image of an after-visit summary are described with reference to FIGS. 4 and 5.

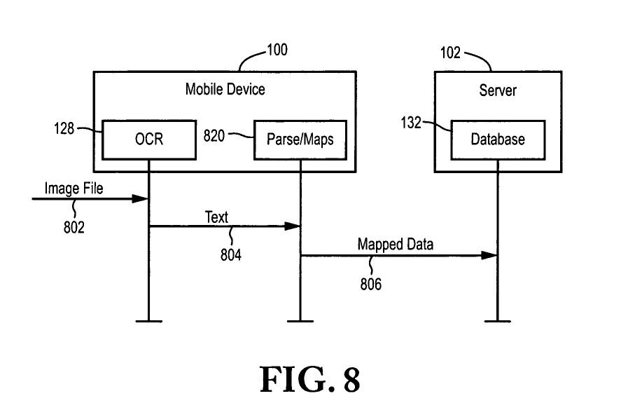

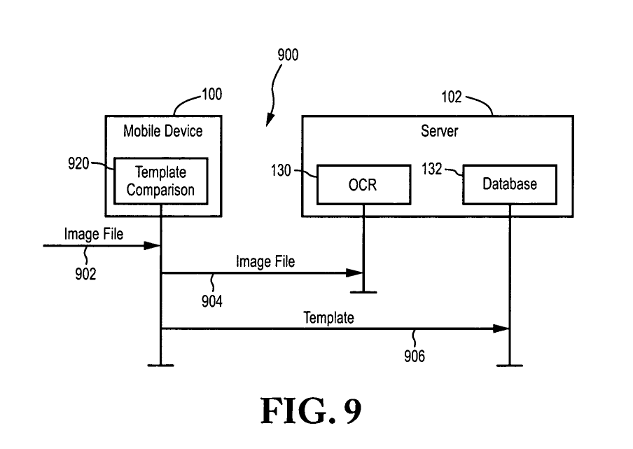

FIGS. 4 and 5 are flow diagrams of methods in accordance with embodiments of the invention. For ease of explanation, the methods are described with reference to the processor 122 of the server 102. However, these descriptions are not meant to be limiting. The methods of FIGS. 4 and 5 would be equally well described with reference to the processor 106 of the mobile device 100 in alternative embodiments of the invention. Likewise, for ease of explanation, the method of FIG. 5 refers to the library 138 of the server 102; however, the method of FIG. 5 would be equally well described with reference to the library 136 of the mobile device 100 in accordance with the alternative embodiments of the invention. Conversely, FIGS. 8 and 9 are presented to show data flow diagrams of the alternative methods in which reference is made to the processor 106 of the mobile device 100 and the library 136 of the mobile device 100. The methods of FIGS. 8 and 9 would be equally well understood by those of skill in the art with reference to the processor 122 of the server and the library 138 of the server 102. Moreover, the locations for storage of the database 132 and/or library 138 are not limited to the memory 124 of the server 102. The database 132 and/or the library 138 can be stored in locations remote to the server 102, or could be stored in a distributed manner any group of locations that include, or do not include, the memory 124 of the server 102.

Turning first to FIGS. 4 and 8, at 400 the method may begin. At 402 data representative of an image of the after-visit summary may be received at a processor 122 of the server 102. At 404, the processor 122 executes commands that cause the data to be applied to an OCR program 130. At 406, the OCR program 130 converts the image into text, which may be editable text. The image may also include graphics, photographs, or other representations that are not amenable to conversion into text by the OCR program 130. Such non-convertible portions of the image may nevertheless be identified for future reference.

Turing to the dataflow of the alternative embodiment of FIG. 8, an image file may be received at 802 by a processor 106 of the mobile device 100 and applied to an OCR program 128 of the mobile device 100. The OCR program converts the image file into text, which may be editable text.

At 408, code running on the processor 122 or incorporated into the OCR program 130 may parse the text into individual words or groups of words or numbers. The parsed text may include a plurality of field descriptors and data corresponding to some or all of the field descriptors. At 410, data corresponding to a given field descriptor is identified, mapped, and subsequently transferred (or copied) to the database 132 to be stored in a location corresponding to the given field descriptor.

Turning to the dataflow of the alternative embodiment of FIG. 8, text may be received at 804 by code running on the processor 106 or incorporated into the OCR program 128, after which the code may parse the text into individual words or groups of words or numbers. The parsed text may include a plurality of field descriptors and data corresponding to some or all of the field descriptors. Data corresponding to a given filed descriptor may be identified and mapped. The mapped data (or a copy thereof) may be received at 806 by the database 132 of the server 102 to be stored in a location corresponding to the given field descriptor.

Some or all of the possible field descriptors that may be utilized during the preparation of after-visit summaries, including one or more of, for example, “patient name,” “provider address,” “date of service,” “medication list,” “vital signs,” “problem list,” “diagnostic test results,” “medication list,” and “medication allergy list” may be pre-stored in the database 132, or location for storing data associated with these descriptors may be reserved in the database 132. Additionally, alternative descriptors such as “laboratory test results” (similar or equivalent to “diagnostic test results”), “blood pressure” and “pulse,” (expected to be encompassed within the field descriptor “vital signs”) may also be pre-stored in the database 132.

In one non-limiting example of an embodiment of the method, the processor 122 may cause the database 132 to be populated by selecting field descriptors that were pre-stored in the database 132, and by determining if the selected field descriptor matched any word or group of words in the converted text. If so, the data associated with the matched field descriptor in the converted text could be mapped (and subsequently transferred) to a corresponding location in the database 132.

In another non-limiting example of an embodiment of the method, the processor 122 may cause the database 132 to be populated by selecting each parsed word or group of words in the converted text and determining if the selected parsed word or group of words matched a predefined field descriptor in the database 132. If the selected parsed word or group of words matched, the data associated with the selected word or group of words would mapped (and subsequently transferred) to a corresponding location in the database 132.

Accordingly, a patient might take an image of an after-visit summary provided by a first medical provider and map the information printed therein (for example, patient name, doctor name, list of medicines, ICD diagnosis, and images not amenable to OCR) to a database 132 such that the patient's name in the after-visit summary was mapped to the field corresponding to the patient's name in the database 132, and the other information from the after-visit summary was likewise also mapped to the fields corresponding to the other information in the database 132.

The exemplary method of FIG. 4 may end at 412.

Turning to FIGS. 5 and 9, at 500, the method may begin. At 502 data representative of the image of the after-visit summary may be received at a processor 122 of the server 102. At 504, the processor 122 executes commands that cause the data received at the processor 122 to be compared to data representative of pluralities of images of after-visit summaries stored in a library of after-visit summaries 138. At 504 if the data received at the processor 122 matches data representative of a pre-stored image in the library 138, the method proceeds to 506. At 506, the processor determines if a template for locating data associated with the matched image in the library exists. If a template exists, the method may proceed to 508.

Turning to the dataflow of the alternative embodiment of FIG. 9, an image file may be received at 902 by a processor 106 of the mobile device 100. The processor 106 may execute commands that cause the image file to be compared to data representative of pluralities of images of after-visit summaries stored in a library of after-visit summaries 136. If the data received at the processor 106 matches data representative of a pre-stored image in the library 136, the processor 106 may forward the template to the sever 102 at 906.

At 508, the data representative of the image received at the processor 122 is applied to an OCR program 130 of the server. At 510, the OCR program 130 converts the image to text. At 512, the processor causes the database 132 to be populated by mapping converted text to predetermined locations in the database 132 according to instructions in the template. The method may end at 514.

In the alternative embodiment of FIG. 9, the image file may be forwarded to an OCR program 130 of the server 102 at 904. The OCR program 130 may convert the image to text, and a processor 122 of the sever 102 may cause the database 132 to be populated by mapping converted text to predetermined locations in the database 132 according to instructions in the template.

Returning to 504, if the data received at the processor 122 does not match data representative of a pre-stored image in the library 138, the method may proceed to 516. At 516, the processor determines if any pre-stored images for comparison remained in the library. If a pre-stored image for comparison remains in the library, the method continues to 518. At 518, the processor increments its comparison to the next pre-stored image in the library 138 and the method returns to step 504. Returning to 516, if no pre-stored images for comparison remain in the library, the method continues to 520. Likewise, at 506 if there is no template for locating data associated with the matched image in the library, the method proceeds to 520.

At 520, the processor 122 executes commands that cause the received data to be applied to an OCR program 130. At 522, the OCR program 130 converts the image into text, which may be editable text. The image may also include graphics, photographs, or other representations, which are not amenable to conversion into text by the OCR program 130. Such non-convertible portions of the image may nevertheless be identified for future reference.

At 524, code running on the processor 122 or incorporated into the OCR program 130 may parse the text into individual words or groups of words or numbers. The parsed text may include a plurality of field descriptors and data corresponding to some or all of the field descriptors. At 526 data corresponding to a given field descriptor may be mapped to a predefined location corresponding to the given field descriptor in the database 132 and transferred (or copied) to that location be stored in a location corresponding to the given field descriptor.

Optionally, at 528, a new template may be created and stored in the library 138 for future use in connection with step 506. The new template may identify, for example, locations of data associated with field descriptors that may be known to exist on the pre-stored image of the after-visit summary stored in the library and used at step 504.

As an alternative to 520 through 528, the data representative of the image received at the processor 122 may be stored in the database 132 as an image file without OCR processing. Alternatively, a user may be notified that no pre-stored images remain and the user may then be asked to designate particular fields thereby training the system with a new pre-stored image. The data may thereafter be mapped accordingly in the database 132.

Following 526, or optionally following 528, the method may proceed to 514 where the method may end.

Various methods, including those described above and other methods known to those of skill in the art, of mapping text converted from the image of the after-visit summary to corresponding fields in the database 132, and populating the database 132, are within the scope of the invention. In other words, embodiments of the invention may utilize various methods to map data from many differently-formatted after-visit summaries, provided to patients from many different EHR systems, into predefined fields in a database 132, thereby creating a database containing structured data.

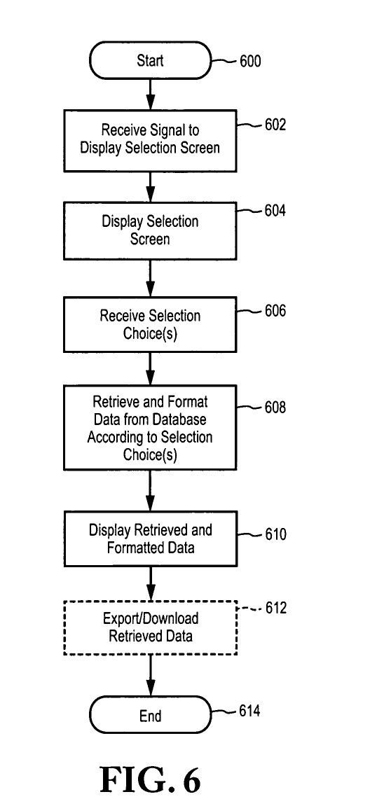

FIG. 6 is a flow diagram of a third method in accordance with an embodiment of the invention. The method of FIG. 6 may find utility when a patient seeks to present data obtained from a collection of after-visit summaries from disparate sources to a first medical provider, where the data may include clinical summaries and/or diagnostic test results obtained from medical providers other than the first medical provider.

A patient, such as an elderly or chronically ill patient, who is in the care of many doctors, will appreciate this utility. The patient's many doctors may not confer with each other. The patients may not be able to recall their diagnoses, all of the medicines they are taking, the dosages, and number of times per day they are taking their medicines. The patients may not even be able to recall who prescribed the medicine or why the medicine was prescribed. Knowing the types and dosages of medicines being taken by a patient may help a medical care provider diagnose a symptom exhibited by a patient. Therefore, in addition to being able to recall clinical summaries and laboratory results, the simple ability of a patient to use his mobile device 100 to obtain a list of all medications being taken, and present that list to any given medical provider at the point of care, can serve to improve the outcome of the patient.

Eliminating unnecessarily duplicated diagnostic tests, and being able to present medically relevant data to a medical provider, by use of the methods, devices and systems in accordance with embodiments of the invention, would contribute toward solving the important real world problem of reducing the number of unnecessarily duplicated diagnostic tests presently prescribed by medical providers. Patients would be spared the time and physical discomfort required for conducting an unnecessarily duplicated diagnostic test, and both patients and/or their insurance companies would be spared the cost of these unnecessary procedures.

Moreover, the inventors of the present invention envision analysis of a cumulative list of all diagnoses for a particular patient. Such an analysis may provide a concise and medically filtered descriptor set. Such a descriptor set could describe the patient's lifetime health status, which could provide a tool for the patient's doctors, and the patient himself, as to the patient's overall state of health. Additionally, the storage of a patient's data in a structured database, over the patient's lifetime, may provide a doctor and/or a patient with a lifetime cumulative health record, which may be useful, for example, in predicting a patient's future health based on past experience with the patient and on comparison of the patient's lifetime cumulative health record with those of other patients of similar, for example, age, weight, sex, and medical conditions.

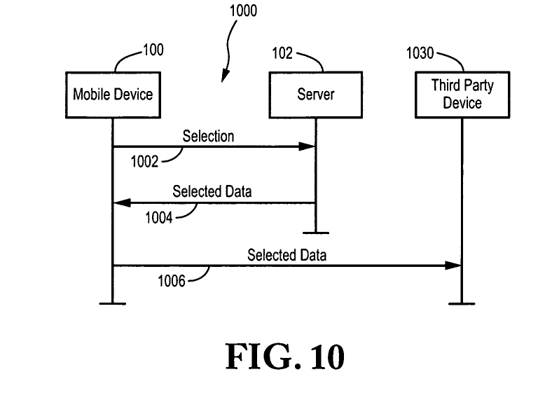

Turning now to FIG. 6, the method may begin at 600. At 602 the processor 106 may receive signals indicative of a command to display, on the display 112 of the mobile device 100, at least one screen configured to allow selection of data from the database 132. At 604, the processor may execute commands that cause the selection screen to be displayed on the display 112 of the mobile device 100. At 606, the processor 106 may receive a signal indicative of a selection of data, which is responsive to the display of the selection screen. As shown in FIG. 10, a selection may at 1002 be sent to the server 102. At 608, the processor may cause data to be retrieved from the database 132 of the server 102, and to be formatted for presentation on the display screen 112 of the mobile device 100. As shown in FIG. 10, selected data may at 1004 be received from the server 102. At 610, the processor may cause the received and formatted data to be displayed on the display screen 112 of the mobile device 100. At 612, the processor may optionally export or download the retrieved data, for example upon request of the medical provider. The data may be downloaded or exported either from the mobile device or from the server. As shown in FIG. 10, the selected data may at 1006 be sent to a third party device such as medical provider computing device. The method may end at 614.

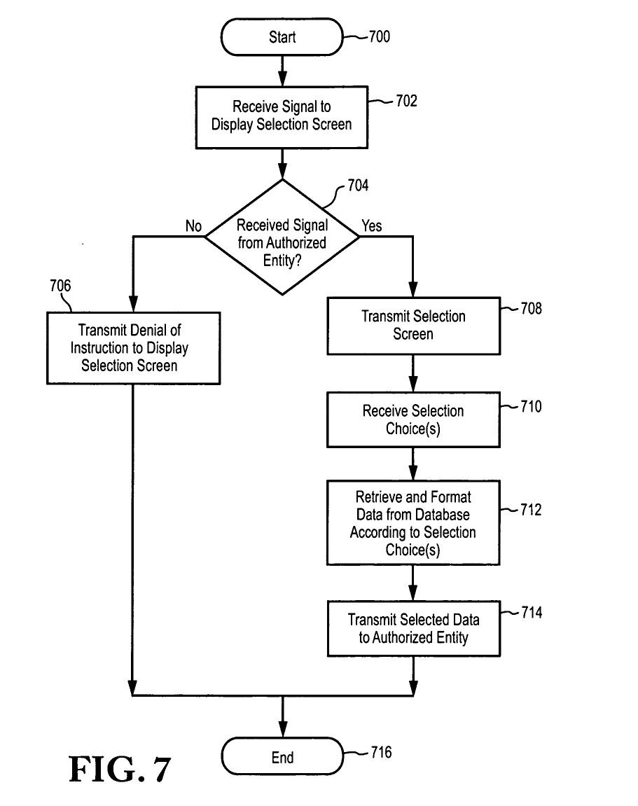

FIG. 7 is a flow diagram of a fourth method in accordance with an embodiment of the invention. The method of FIG. 7 may be employed by the user, or by first responders with approval of the user. The user's approval may be obtained prior to implementing the method. Approval may be required to comply with federal, state, and/or local laws related to privacy of data and/or privacy of medical data. In an exemplary use of the method of FIG. 7, an emergency call center (FIG. 3, 314) may receive a call from a user or a third party. The call may include a request for medical assistance for the user. Further, the received call from the user or third party may include Global Positioning System (GPS) data indicating a location of the user device. The call center 314 may dispatch an emergency services vehicle to the location of the patient. Typically, the call center 314 will ask medical questions that can be answered by the user or the third party. These may include questions about respiration, state of consciousness, areas of bleeding, etc. The call center 314 may ask medical questions that cannot be answered by the user (depending on the user's state and/or the user's memory) or the third party. These questions may include questions about prior hospitalizations, seizures, prior losses of consciousness, pulmonary disease, cancer, allergies to medicines, identities of preferred medical providers, even end of life instructions/wishes, etc. However, if the user is identified as having previously given permission for all or some of the data stored in database 132 to be uploaded by the call center 314, or if laws are passed giving such call centers 314 the authority to upload such data with or without user pre-approval, the data can be immediately retrieved and put to meaningful use for the benefit of the user. The method of FIG. 7 may be used, for example, by the call center 314, an emergency responder, or a hospital prior to contact with the user, or anytime thereafter. Moreover, the call center 314 can upload the data from the database 132 and transfer some or all of the uploaded data to, for example, the emergency responder proceeding or at the scene of an accident involving the user, and/or to the a hospital that will or has received the user. Knowing the medical history of a patient (i.e., the user) prior to seeing the patient can improve the efficacy of treatment and speed at which medical services are provided to the patient and, at least in these ways, provide an improvement in the patient's outcome.

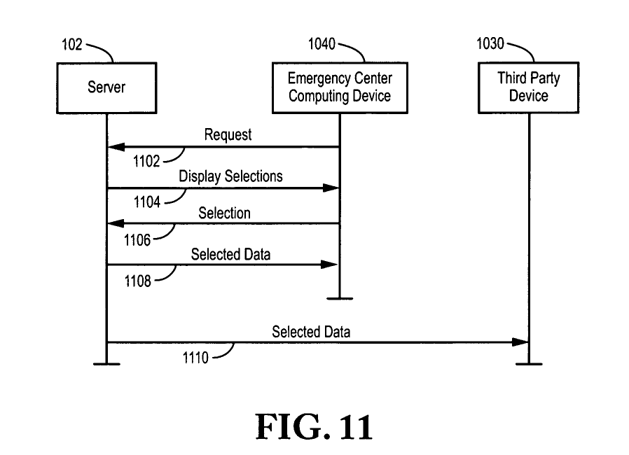

Turning now to FIG. 7, the method may begin at 700. At 702, a processor 122 of a server 102 of a system configured to aggregate health related data of a plurality of users, received from a plurality of disparate sources, and store the aggregated data in a structured database, may receive a signal indicative of a command to display at least one screen configured to allow selection of data personal to one of the plurality of users from the structured database. As shown in FIG. 11, a request may be received at 1102 by the server 102 from an emergency center computing device. The display may be made on, for example, a display screen (not shown) of an emergency call center 314. At 704, the processor 122 may execute code to verify that the received signal is from an entity authorized to retrieve personal data of the user. The verification may be made, for example, by comparing identification data received with, or in conjunction with, the received signal to a pre-defined list of the identification data of authorized entities. The verification can be made in any other way without departing from the scope of the invention. At 706, the processor 122 of the server 102 may execute commands that cause a responsive signal to be transmitted, where the responsive signal is representative of a denial to retrieve the personal data, if the received signal is not from an authorized entity. Alternatively, at 708, the processor 122 of the server 102 may execute commands that cause a responsive signal to be transmitted, where the responsive signal is representative of a selection screen identifying personal data available to the authorized entity. According to predefined criteria, some or all of the users data stored in the structured database may be made available for selection. As shown in FIG. 11, display selections may at 1104 be transmitted from the server 102 to the emergency center computing device.

At 710, the processor 122 may receive a signal indicative of a selection of the personal data. As shown in FIG. 11, a selection may at 1106 be received by the server 102 from the emergency center computing device. At 712, the processor 122 may execute code to cause the selected personal data to be retrieved from the structured database and formatted for transmission. At 714, the processor 122 may transmit the selected data to the authorized entity. As shown in FIG. 11, selected data may at 1108 be transmitted from the server 102 to the emergency center computing device. Optionally, the selected data may at 1110 be transmitted from the server 102 to a third party device. Similar to transmission, the processor 122 may grant permission to the authorized entity to upload the selected data from the structured database. The method may end at 716. The authorized entity could, for example, be a First Responder 316, a hospital 318, or another entity that could provide an improved outcome for a patient via meaningful use of the patient's health related data.

Returning now to FIG. 3, at least four scenarios presenting real world benefits of the use of the exemplary methods of the invention described herein can be demonstrated using the illustration of FIG. 3.

In the first scenario, the first patient has seen two doctors and has had care provided by at least one additional doctor at hospital. If the first patient next goes to a fourth doctor, that doctor will not be able to easily, or in a timely fashion, obtain the clinical summaries and test results from the other doctors. This leads to many problems, because in the medical field knowledge of the patient's health history is of critical importance.

One of the greatest problems in healthcare is duplication of tests. Say, for example, the fourth doctor would like to see the results of a typical blood screening of the patient. Similar to a scenario described above, the fourth doctor may not know, or may not have access to, the results of the exact test that he wanted, which was taken by one of the patient's other three doctors only two months earlier. If the fourth doctor had access to these previous blood test results, he might be able to determine that those test results were adequate. In other words, the fourth doctor would not reorder the tests. On the other hand, if the fourth doctor did not have access to the results, then he would reorder the test. This leads to unnecessary duplication of tests, inconvenience for the patient, and added risk for the patient because the patient is directed by the fourth doctor to have an otherwise unnecessary test.

However, in the first scenario, the first patient has captured the images of the first, second, and third after-visit summaries 300, 302, 304, and transferred those images to the server 102 for processing according to the exemplary methods described in connection with FIGS. 4, 5, 8, and 9. The patient, using the exemplary method described in connection with FIGS. 6 and 10, would be easily able to obtain and present the results of the blood tests taken only two months earlier to the fourth doctor. In fact, by practicing the exemplary methods of the invention for the embodiments described herein, the patient can show any doctor, at the point of care, using the patient's own handheld mobile device 100, a chart, a diagnosis, some records, or any medically relevant item stored in the database 132.

Moreover, in accordance with an embodiment of the invention, the patient could export, to the doctor, only the data that the doctor wants. That is, using the patient's mobile device 100, the doctor gets to select the information he desires to view and/or download at the point of care. This is a benefit to the doctor as well as the patient. Doctors do not want to receive and review a patient's entire medical history as recorded by another doctor. The doctor benefits by receiving only that information that he selects from the patient's entire medical history (compiled by the patient from many disparate sources) as stored on the database 132. The patient benefits by possibly being able to receive a well-informed diagnosis and treatment earlier than if the doctor had to wait for information from other doctors, or wait for results of diagnostic tests that were already available from the database 132.

The second scenario relates to the concept of Clinical Decision Support (CDS) tools. The illustration of FIG. 3 portrays a database 132 that receives information from two patients; however, it will be understood that the system may receive information from any number of patients. It is believed that the number of patients providing data for storage in the database 132 may be only limited by the amount of memory space allocated to the database. It is believed that after some period, for example one year, a database in accordance with the embodiments of the invention described herein (similar to database 132) may comprise records of medical data from one million patients. In this scenario, this data, when aggregated, could be used to help improve the outcomes of many patients.

A first example of a CDS tool may involve looking at outcomes based on a combination of data points such as BMI (body mass index, more accurate than weight) and mean Blood Pressure to identify a subgroup of patients (e.g., patients with BMI greater than 30 and mean diastolic BP greater than 90), which has a statistically significantly higher incidence of stroke. The resulting CDS may state that this group would thus be candidates for aggressive combination weight loss and antihypertensive therapy to lower the incidence of stroke. While such an approach might seem intuitive, third party payers only approve new therapeutic regimens for proven clinical issues (which, may indicate areas in which it is proven that intervention saves future expenditure).

A second example of a CDS tool may be an algorithm to compare the data of millions of patients to identify trends within the data. For example, by knowing the medications that patients are taking, an algorithm may be designed and implemented to compare the weight of all patients taking a certain medication to determine, for example, if after beginning this medication the patient's weight increased or decreased over time. As an additional example, methods, devices, and systems in accordance with embodiments of the invention may use the data stored in the database 132 to identify adverse consequences resulting from taking certain medications or combinations of medications over time. Algorithms could be designed and implemented to compare the ICDs of all such patients to determine if a certain one or more ICDs are increasing with respect to those patients in comparison to patients that were not taking the particular medicine or combination of medicines.

It should be understood that a given EHR system could predict trends from after-visit summaries of patients using the given EHR system, but embodiments of the present invention could predict trends from after-visit summaries of patients using any number of disparate EHR systems. Accordingly, the basis for trend prediction is greater, and possibly more accurate, when using embodiments of the present invention, in comparison to using a single EHR system. Further, the fact that different medical providers using different EHRs may also have different specialties. Accordingly, embodiments of the present invention may contain parameters from multiple organ systems. For example, a gastroenterologist may have data points regarding the gastrointestinal tract, while a cardiologist may have data points describing the cardiovascular system. Embodiments of the present invention, which aggregate data points for multiple providers, may enable examination, aggregation, comparison, and analysis of these multiple data points and provide a more complete picture of health.

Therefore, it is believed that trends in data would appear quicker in a database comprising data drawn from a plurality of disparate EHR systems as opposed to only one EHR system. Therefore, by use of methods, devices and systems in accordance with embodiments of the invention described herein, it may be possible to identify adverse side effects of medications and/or diagnostic or therapeutic treatments much earlier than ever before possible.

The Meaningful Use program requires that healthcare providers use data to improve the outcome of their patients. As described above, methods, devices, and systems in accordance with embodiments of the invention can use the data stored in the database 132 to implement this requirement.

The third scenario relates to the use of electronic data to improve outcomes that will improve a patient's life. Returning to FIG. 3, as described earlier, the second patient has installed a wireless enabled scale 308 in his home. The second patient has an existing diagnosis of congestive heart failure. Each morning the second patient weighs himself on the wireless enabled scale 308. The wireless enabled scale transmits the measured weight to the server 102 via either wireless path 310 or wireless path 312. The processor 122 of the server 102 compares each day's measurement to the previous day's measurement. If more than a one-pound weight change in a day is detected, a “care alert” may be generated and transmitted to the patient, his doctor, and/or any other persons that the patient has previously defined as a recipient of such alerts. The care alert is needed because the weight gain may be due to an increase in fluid surrounding the heart. In such a case, it is very important for the patient to see his doctor quickly. The automatic transmission of such an alert can mean the difference between the patient seeing his doctor for a $50 visit to evaluate and manage the weight gain versus a $3000 hospitalization that would result from ignoring the weight gain to a point where the patient cannot breathe.

The fourth scenario also relates to the use of electronic data to improve outcomes that will improve a patient's life. Again, returning to FIG. 3, in the fourth scenario a patient (the user) suffers a seizure while out with friends. One of the friends dials 911 to reach an emergency call center 314. The call may be placed using, for example, her own cell phone, the user's cell phone, any land line, or any other device available. The emergency call center 314 obtains needed initial information, such as location, patient's state, patient's name and dispatches a first responder 316 to the location provided. The patient's medical records may indicate that the patient is allergic to drug X, has a history of seizures, and is presently taking drug D to control his seizures. Unknown to the call center operator, drug X is the primary drug used to stop prolonged seizures; the first responder's protocol dictates that drug X should be administered as soon as possible after contact with the patient having a prolonged seizure. However, in a clear example of a meaningful use of the electronic data of the server 102, a text including the patient's unlock code maybe sent from the call center operator to the first responder giving the first responder access to only emergency information, including the patient's history of seizures, allergy to drug X, and use of drug D. Referring to his protocol, or upon instructions from a medical doctor via wireless device/emergency services radio, the first responder abandons his plan to administer drug X and instead administers drug Y. The patient is transported to a hospital 318, which has received the patient's emergency information medical history from the emergency call center 314, and continues with treatment of the patient in view of that history. It should be noted at this point that in an embodiment, the only way an entire patient record can be accessed by someone other than the patient themselves, is by the patient giving such access and/or authorization to said, e.g., emergency call center operator, first responder, or hospital.

Use of the systems and methods described herein may enable users to derive benefits from mobile devices that may not include cameras. Examples of such mobile devices include personal electronic devices that continually record activity (such as the number of steps taken or distance traveled vs. time) and/or biological parameters (such as heart rate or blood oxygen levels vs. time), as well as electronic devices that may be used on-demand (such as a sphygmomanometer, glucose meter, or digital scale). The data collected by such mobile devices may be similar to data collected from optical character recognized After-Visit-Summaries, at least in that the data can be associated with a particular user, aggregated, stored, analyzed, used to trigger messages (such as warnings, alerts, and/or advice), and/or presented on-demand to a user (or an authorized entity) at any time and in any one of a various number of formats. Given an ability of such mobile devices to transmit their collected data to a system operating in accordance with the embodiments of the invention, medical providers (and their patients) obtain meaningful use of the recorded data for any number of the same reasons as described herein in connection with other embodiments of the invention. In addition, a still further benefit can be achieved by use of such devices in combination with embodiments of the invention as described herein; much like Electronic Health Record (EHR) systems described herein, the various devices are not set up to interact with each other, nor to aggregate the results to a common format or become interactive.

Moreover, methods, devices, and systems in accordance with embodiments described herein enable implementation of, and provide meaningful contributions to, “home telecare,” “telemedicine,” and “telehealth.” Home telecare broadly relates to remote services offered to, for example, elderly and disabled people; such services may allow those people to remain living in their own homes (as opposed to a nursing or assisted living facility). Telemedicine broadly relates to remotely offered services that provide diagnosis, treatment, and/or prevention of medical issues to people that have difficulty (due, for example, to remote location or impairment of physical mobility) getting to a medical services provider. Telehealth broadly relates to health related services and information delivered remotely, for example, via wired or wireless telephone systems.

Still further problems may be overcome and benefits achieved by practice of the methods, and use of the devices and systems described herein. For example, not only can users capture and store health related information from multiple EHR systems and doctors to help improve outcomes, but they can also use mobile devices that include cameras in accordance with embodiments described herein to record financial aspects of their medical visits. For example, after a patient's examination/treatment at a given point of care, the patient typically proceeds to a counter to pay. An assistant may check the patient's insurance coverage and present the patient with a bill. The assistant may inform the patient that he owes a co-pay of $40 or that the patient is responsible to pay $1,500. Of course, it will be understood that these values and this scenario are provided for example only. A patient's experience will vary depending on the procedures and/or examinations conducted and the insurance coverage held by the patient. The patient can use his mobile device to check this bill, the co-pay, and the patient responsibility amount against insurance information that may be stored in database 132, along with the patient's medical information. The patient can make payment at the counter, obtain a receipt for the payment along with his bill, and use his mobile device, at the point of care, to capture the image of the bill and receipt. In accordance with embodiments described herein, the captured image may be optical character recognized on the mobile device (or at a remote location). The resultant data may be parsed and stored as financial information in a similar manner to that already described in connection with medical information. Similar to medical information, the financial information may be retrieved to provide a benefit to the user. For example, the user could keep track of his cumulative copays and total out of pocket expense, compare these to his deductibles or perhaps his health savings account (HSA) or Flexible Spending Account (FSA), and make better decisions about how to use his health care dollars. This financial information is valuable to patients, companies that employ patients, and insurance companies, etc.

Still further, the systems described herein may include functionality to permit a user to have access to and decision authority over family member's (such as the user's child or elderly parent) health (and heath related financial) information stored in the database 132. The systems described herein may implement methods to obtain and store legal authorizations, health care directives, authorizations to permit access to medical (and/or financial) information, etc. This functionality may offer users the ability to manage health (and health related financial) issues for themselves as well as members of their families and extended families. The need for users to have access to and decision authority over a parent's information is becoming greater as chronic care grows and lifespans are extended.

The foregoing embodiments and advantages are merely exemplary and are not to be construed as limiting the present disclosure. The present teachings can be readily applied to other types of methods, devices, and systems. For example, although a specific context example of after-visit summaries provided medical providers is discussed, the methods, devices, and systems for multi-format data aggregation may be applied in other contexts where it is desirable to leverage optical image capturing devices to capture images, convert those images to text, parse, categorize, analyze and store the data as structured data in one or more databases to thereby improve aggregation of the data, to improvise the distribution of subsets of the aggregated data to necessary parties, and to thereby improve identification of adverse outcomes resulting from making certain decisions based on the subsets of the aggregated data. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments. For example, some operations may be combined while others may be separated. As a further example, the order of some operations may be altered. As still a further example, although some functionality is shown as being resident to the client 100 or the server 102, such functionality (e.g., OCR functionality) may be provided by third party providers of such functionality.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds, are therefore intended to be embraced by the claims.

What is claimed is:

1. A method of populating a personal health record (PHR) with data culled from a plurality of images of a plurality of printed documents provided by a plurality of medical providers to a patient at a plurality of points of care after the patient visits the plurality of medical providers, the method comprising:
receiving at a point of care, at a processor of a mobile device, electronic data representative of an image of a printed document;
applying the electronic data to an optical character recognition program configured to convert the image of the printed document into text;
parsing the text into a plurality of fields, the plurality of fields comprising data representative of information related to the patient's visit to a medical provider;
storing the parsed text in a database; and
displaying at least some of the text on a display screen of the mobile device,
wherein a presentation format of the printed document differs from a presentation format of at least one of the plurality of printed documents.

2. The method of claim 1, further comprising:
receiving at a second point of care, at the processor of the mobile device, second electronic data representative of a second image of a second printed document;
applying the second electronic data to the optical character recognition program, the optical character recognition program configured to convert the second printed document into second text;
parsing the second text into a second plurality of fields, the second plurality of fields comprising data representative of information related to the patient's visit to a second medical provider;
storing the parsed second text in the database; and
displaying at least some of the text and at least some of the second text on a display screen of the mobile device,
wherein the second printed document is formatted different than the printed document.

3. The method of claim 1, wherein the data representative of the image of the printed document includes data representative of a problem list, diagnostic test results, a medication list, or a medication allergy list.

4. The method of claim 1, wherein the image is converted into editable text.

5. The method of claim 1, wherein the plurality of fields comprise:
a plurality of first fields corresponding to a plurality of data identifiers; and
a plurality of second fields, each second field comprising data associated with one of the plurality of data identifiers.

6. The method of claim 1, further comprising:
receiving at the processor of the mobile device a command to display a subset of the plurality of fields in the database on a display of the mobile device; and
displaying the subset of the plurality of fields on the display of the mobile device.

7. The method of claim 6, further comprising:
downloading, using the mobile device, data representative of the subset of the plurality of fields.

8. The method of claim 1, wherein the database comprises patient data, for a given patient, received from the plurality of medical providers, the plurality of medical providers being unrelated.

9. The method of claim 1, wherein the database comprises patient data of a plurality of patients, received from the plurality of medical providers, the plurality of medical providers being unrelated.

10. The method of claim 1, further comprising:
displaying, on the mobile device, at least one screen configured to allow selection of data from the database;
receiving, at the processor of the mobile device, a signal indicative of a selection of data from the database in response to the displaying of the at least one screen; and
transmitting, from a transceiver of the mobile device, a signal indicative of a request for receipt of selected data.

11. The method of claim 10, further comprising:
receiving, at the processor of the mobile device, the selected data; and
displaying, on a display of the mobile device, the selected data.

12. The method of claim 11, further comprising:
downloading, using the mobile device, the selected data.

13. The method of claim 10, wherein the selected data includes data representative of a problem list, diagnostic test results, a medication list, or a medication allergy list.

14. A mobile device, comprising:
a camera;
a transmitter;
a memory; and
a processor operatively coupled to the camera, transmitter, and memory, wherein the memory comprises instructions that when executed by the processor cause the processor to:
receive electronic data representative of an image of a printed document from the camera;
apply the electronic data to an optical character recognition program configured to convert the image of the printed document into text;
parse the text into a plurality of fields, the plurality of fields comprising data representative of information related to a patient's visit to a medical provider; and
transmit the parsed data, from the transmitter, whereby the transmitted data is to be stored in a database remote from the mobile device, and
wherein the mobile device is used at a point of care to record the image of the printed document provided by the medical provider to the patient at the point of care, and
wherein a presentation format of the printed document differs from a presentation format of at least one other printed document received as electronic data from the camera.

15. The mobile device of claim 14, wherein the memory further comprises instructions that, when executed by the processor, further cause the processor to:
receive second electronic data representative of a second image of a second printed document from the camera;
apply the second electronic data to the optical character recognition program, the optical character recognition program configured to convert the second image of the printed document into second text;
parse the second text into a second plurality of fields, the second plurality of fields comprising second data representative of information related to a patient's visit to a second medical provider; and
transmit the second parsed data, from the transmitter, whereby the second transmitted data is to be stored in the database remote from the mobile device,
wherein the mobile device is used at a second point of care to record the second image of the second printed document provided by the second medical provider to the patient at the second point of care, and
wherein the second printed document is formatted different than the printed document.

16. The mobile device of claim 15, further comprising:
a receiver operatively coupled to the processor; and
a display operatively coupled to the processor,
wherein the memory further comprises instructions that, when executed by the processor, cause the processor to:
receive, at the receiver, selected data from the transmitted data and the second transmitted data, whereby the selected data was stored in the database remote from the mobile device; and
display, on the display of the mobile device, the selected data.

17. A system for recording and monitoring health parameters of a user, the system comprising:
a first device configured to receive and store data representative of at least one health parameter of the user; and
a second device configured to measure the at least one health parameter of the user and transmit data representative of the at least one health parameter of the user to the first device;
the first device further configured to compare the received data representative of the at least one health parameter of the user with the stored data and transmit a notification if a result of the comparison exceeds a predetermined limit.

18. The system of claim 17, wherein the first device is a mobile device and the second device comprises a weight scale, a glucose meter, or a sphygmomanometer.

19. The system of claim 17, further comprising a mobile device, wherein the first device is a server, the second device transmits the data representative of the at least one health parameter of the user to the first device via a transceiver of the mobile device, and the second device comprises a weight scale, a glucose meter, or a sphygmomanometer.

20. The system of claim 17, wherein the notification is transmitted to a mobile device of the user.

21. A method of obtaining medical information of a patient by a third party, comprising:
receiving, at a processor of a system configured to aggregate medical data of a plurality of users from a plurality of disparate sources and store the aggregated data in a structured database, a signal indicative of a command to display at least one screen configured to allow selection of data personal to one of the plurality of users from the structured database;
verifying that the received signal is from an entity authorized to retrieve personal data of the user;
executing commands that cause a response signal to be transmitted, wherein:
the responsive signal is representative of a denial to retrieve the personal data, if the received signal is not from an authorized entity, or
the responsive signal is representative of a selection screen identifying personal data available to the authorized entity;
receiving a signal indicative of a section of the personal data;
retrieving and formatting for transmission the selected personal data; and
transmitting the selected data to the authorized entity.

22. The method of claim 21, wherein verifying comprises matching identification data received with, or in conjunction with, the signal indicative of a command to display at least one screen, to a predetermined list of authorized identification data.

23. The method of claim 21, wherein the signal indicative of a command to display at least one screen configured to allow selection of data is received from one of the plurality of users or from an emergency call center.

24. The method of claim 21, wherein the authorized entity is an emergency call center or a hospital.

25. The method of claim 21, wherein transmitting includes granting permission to upload data from the structured database.
